(19) United States
(12) Patent Application Publication
(10) Pub. No.: US 2025/0117600 A1
(43) Pub. Date: Apr. 10, 2025

(54) VEHICLE-MOUNTED APPARATUS AND CONTROL METHOD THEREOF

(71) Applicants: HON HAI PRECISION INDUSTRY CO., LTD., New Taipei City (TW); Foxconn Technology Group Co., Ltd., Guangdong Province (CN)

(72) Inventors: Yung-Hui LI, New Taipei City (TW); I-Bin LIAO, New Taipei City (TW); Van Nhiem TRAN, New Taipei City (TW); Kinan Remy MARTIN, New Taipei City (TW); Lun-Wei KU, New Taipei City (TW)

(21) Appl. No.: 18/906,145

(22) Filed: Oct. 3, 2024

Related U.S. Application Data
(60) Provisional application No. 63/587,726, filed on Oct. 4, 2023.

(51) Int. Cl. G06F 40/40; B60K 35/28; G06V 10/40; G06V 20/56

(52) U.S. Cl. CPC G06F 40/40; B60K 35/28; G06V 10/40; G06V 20/56; B60K 2360/16; B60K 2360/21

(57) ABSTRACT

A vehicle-mounted apparatus and vehicle-mounted apparatus control method are provided. The vehicle-mounted apparatus is configured on a vehicle in which a user rides. The apparatus captures an environmental image around the vehicle. The apparatus inputs the environmental image into a composite model to generate a corresponding environmental text, wherein the environmental text is configured to describe the environmental image. The apparatus inputs the environmental text into a language model to generate a response text corresponding to the vehicle. The apparatus executes an interactive operation corresponding to the user based on the response text.

### CROSS-REFERENCE TO RELATED APPLICATION

This application claims priority to U.S. Provisional Application Ser. No. 63/587,726, filed Oct. 4, 2023, which is herein incorporated by reference in its entirety.

### BACKGROUND

### Field of Invention

The present disclosure relates to a vehicle-mounted apparatus and control method thereof. More particularly, the present disclosure relates to a vehicle-mounted apparatus and control method thereof for generating texts.

### Description of Related Art

According to relevant research, dialogue can help reduce fatigue and improve concentration of the driver. However, in existing vehicle-mounted technology, there is a lack of driver assistance technology that can interact with the driver based on the surrounding environment of the vehicle.

In view of this, how to provide vehicle-mounted technology to interact with the driver based on the surrounding environment of the vehicle is the goal that the industry strives to work on.

### SUMMARY

The disclosure provides a vehicle-mounted apparatus, installed on a vehicle a user ridden in. The vehicle-mounted apparatus comprises a camera, an output interface, and a processor. The camera is configured to capture an environment image around the vehicle. The processor is communicatively connected to the camera and the output interface relatively. The processor inputs the environment image into a composite model to generate an environment text, which the environment text is configured to describe the environment image. The processor inputs the environment text into a first language model to generate a first response text corresponding to the vehicle. The processor generates a control signal corresponding to the first response text to control the output interface in order to execute an interactive operation corresponding to the user.

The disclosure further provides a control method, being adapted for use in a vehicle-mounted apparatus, wherein the vehicle-mounted apparatus is installed on a vehicle a user ridden in, and the control method comprises the following steps: capturing an environment image around the vehicle; inputting the environment image into a composite model to generate an environment text, wherein the environment text is configured to describe the environment image; inputting the environment text into a first language model to generate a first response text corresponding to the vehicle; and executing an interactive operation corresponding to the user based on the first response text.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a vehicle-mounted apparatus according to a first embodiment of the present disclosure.

FIG. 2 is a flow diagram illustrating the vehicle-mounted apparatus generating a response text based on an environment image according to some embodiments of the present disclosure.

FIG. 3 is a schematic diagram illustrating a composite model according to some embodiments of the present disclosure.

FIG. 4 is a flow diagram illustrating generating a response text by using a language model according to some embodiments of the present disclosure.

FIG. 5 is a flow diagram illustrating a vehicle-mounted apparatus control method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

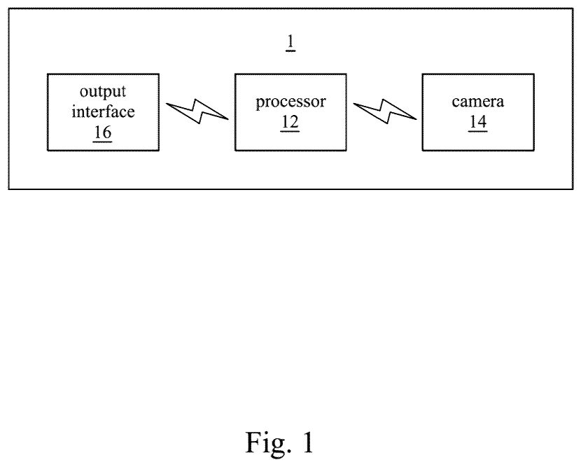

Please refer to FIG. 1, which is a schematic diagram illustrating a vehicle-mounted apparatus 1 according to a first embodiment of the present disclosure. The vehicle-mounted apparatus 1 is installed on a vehicle in which a user (e.g., driver, passenger) ride. The vehicle-mounted apparatus 1 comprises a processor 12, a camera 14, and an output interface 16, wherein the processor 12 communicatively connected to the camera 14 and the output interface 16 relatively. The vehicle-mounted apparatus 1 is configured to provide content for interacting with the user based on the surrounding environment of the vehicle.

In some embodiments, the processor 12 comprises a central processing unit (CPU), a graphics processing unit (GPU), a multi-processor, a distributed processing system, an application specific integrated circuit (ASIC), and/or a suitable processing unit.

The camera 14 is configured to capture an environment image around the vehicle. In some embodiments, the camera 14 comprises one or more image capturing units for capturing the surrounding environment image, and the image capturing units are installed on the vehicle. In practical application, the vehicle-mounted apparatus 1 may select the number and positions of the image capturing units installed on the vehicle according to needs. The environment image records the surrounding environment of the vehicle, e.g., other vehicles, road markings, signs, obstacles, scenes, weather, other objects, or information. Also, the relationships such as relative distances and positions between the objects in the environment and the vehicle are able to be recognized based on the environment image.

The output interface 16 is configured to output the interactive content generated by the processor 12. In some embodiments, the output interface 16 comprises a display screen, a speaker, a light, and/or other components installed on the vehicle.

In some examples, the camera 14 merges multiple images captured by multiple image capturing units into an environment image based on the positions where the image capturing units installed. In other embodiments, the camera 14 takes multiple images captured by multiple image capturing units as the environment image and marks the images based on the positions where the image capturing units installed in order to indicate the relative positions of the images corresponding to the vehicle, e.g., front image, rear image, right image, left image, etc.

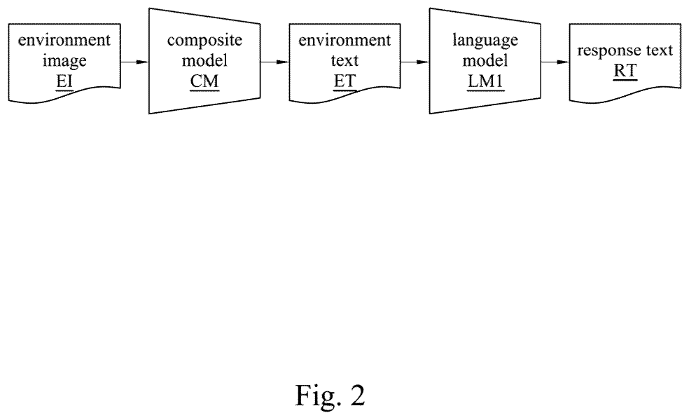

About the operations of the vehicle-mounted apparatus 1 generating texts for interacting with the user based on images, please refer to FIG. 2, which is a flow diagram illustrating the vehicle-mounted apparatus 1 generating a response text RT based on an environment image EI according to some embodiments of the present disclosure.

As shown in FIG. 2, first, the processor 12 inputs the environment image EI into the composite model CM to generate the environment text ET, wherein the environment text ET is configured to describe the environment image EI.

Next, the processor 12 inputs the environment text ET into the language model LM1 to generate the response text RT corresponding to the vehicle.

After generating the response text RT, the processor 12 generates a control signal corresponding to the response text RT to control the output interface 16 to execute an interactive operation corresponding to the user.

Specifically, in order to input into the language model LM1 for operating, the processor 12 transforms the environment image EI captured by the camera 14 into the environment text ET in literal form by using the composite model CM first.

Next, the processor 12 generates the response text RT corresponding to the environment text ET by using the language model LM1, wherein the response text RT is generated based on the environment image EI.

Finally, the processor 12 controls the output interface 16 to output the response text RT by displaying, playing, or other form to interact with the user.

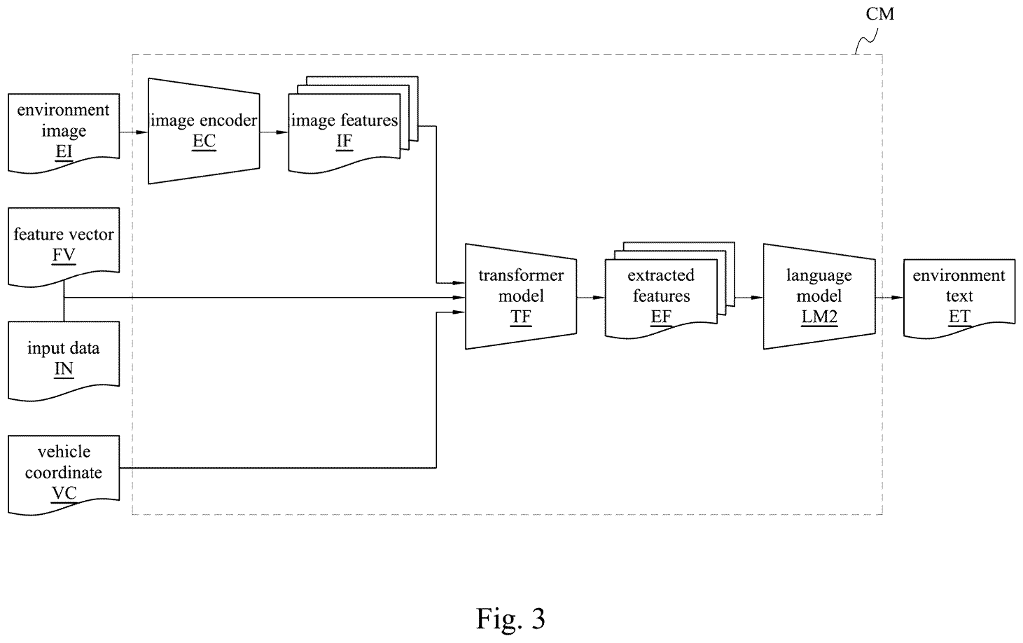

About the details of the composite model CM, please refer to FIG. 3, which is a schematic diagram illustrating a composite model CM according to some embodiments of the present disclosure, wherein the composite model CM comprises a image encoder EC, a transformer model TF, and a language model LM2.

As shown in FIG. 3, in some embodiments, the composite model CM inputs the environment image EI into the image encoder EC to generate a plurality of image features IF.

Specifically, the image encoder EC is an encoder of the transformer model TF and configured to extract features in the environment image EI (i.e., the image features IF).

Next, the composite model CM inputs the image features IF and a query into the transformer model TF to generate a plurality of extracted features EF, wherein the query comprises the feature vector FV.

Specifically, the transformer model TF is a model comprising multiple layers of transformers, wherein each layer of the transformers comprises self-attention calculations for the image features IF and cross-attention calculations based on the image features IF and the query. Furthermore, after completing the calculations, each layer of the transformers feedforwards the calculation result to the next layer.

After multiple layers of transformer calculations, the transformer model TF generates the extracted features EF, and the extracted features EF are features extracted from the image features IF by the composite model CM referring to the parameters of the feature vector FV, wherein the parameters of the feature vector FV may adjust the weights corresponding to different features in the extracted features EF, and the parameters may be adjusted correspondingly after multiple calculations.

Finally, the composite model CM inputs the extracted features EF into the language model LM2 to generate the environment text ET.

In some embodiments, the language model LM2 is a decoder corresponding to the image encoder EC and the transformer model TF. Namely, the language model LM2 is configured to transform the extracted features EF extracted by the transformer model TF into the environment text ET in the form of natural language. In some embodiments, the language model LM2 is a trained large language model (LLM).

The environment text ET generated by the language model LM2 is a text describing the environment image EI. For example, the environment text ET comprises statuses of other objects around the vehicle such as “there is a truck parked on the side of the street, a white van and a black car driving down the road”.

In some embodiments, the environment text ET comprises one of an object label or a direction label or a combination thereof. For example, since the environment image EI is labeled by a relative position corresponding to the vehicle, the corresponding environment text ET comprises an attribute of the surrounding object and a relative position between the vehicle and the surrounding object, e.g., “In the front view, there is a truck parked on the side of the street; From the front left view, you can see green bushes in front of a large building and a concrete curb running along it; Checking out your rear right view lets you see two people walking”.

It is noted that, the vehicle-mounted apparatus 1 may set the language of the environment text ET outputted by the language model LM2 according to needs, and the present disclosure is not limited thereto.

In some embodiments, the vehicle-mounted apparatus 1 further takes the location coordinate of the camera 14 capturing the environment image EI as a parameter and inputs the parameter into the composite model CM for extracting features. Please refer to FIG. 3 again, in response to receiving the vehicle coordinate VC corresponding to the vehicle capturing the environment image EI, the composite model CM inputs the vehicle coordinate VC, the image features IF, and the query into the transformer model TF to generate the extracted features EF. Accordingly, the composite model CM is able to generate the corresponding environment text ET referring to the position of the vehicle.

In some embodiments, the vehicle-mounted apparatus 1 further comprises an input interface (not shown in the figures), e.g., a microphone, a touch screen, a keyboard, a touchpad, etc. Accordingly, the vehicle-mounted apparatus 1 is able to receive an input data from the user such as voice input and/or typing input.

When the vehicle-mounted apparatus 1 receives inputs from the user by the input interface, for example, the user asks the vehicle-mounted apparatus 1 about driving the vehicle, the vehicle-mounted apparatus 1 inputs the input data from the user into the composite model CM to extract the corresponding features and generates the corresponding the environment text ET. For example, once the user asks about the surrounding vehicle, the composite model CM extracts more features related to the surrounding vehicle from the environment image EI.

Specifically, as shown in FIG. 3, in response to receiving an input data IN, the composite model CM generates the query based on the input data IN and the feature vector FV; and the composite model CM inputs the image features IF and the query into the transformer model TF to generate the extracted features EF.

For example, after the vehicle-mounted apparatus 1 receives the input data IN, the processor 12 transforms the input data IN into a form of the query. After that, the processor 12 appends the input data IN with the feature vector FV and further inputs the appended data into the transformer model TF as the query for calculation. Accordingly, the composite model CM is able to generate the environment text ET based on the input data IN to provide the language model LM1 with related information for calculation.

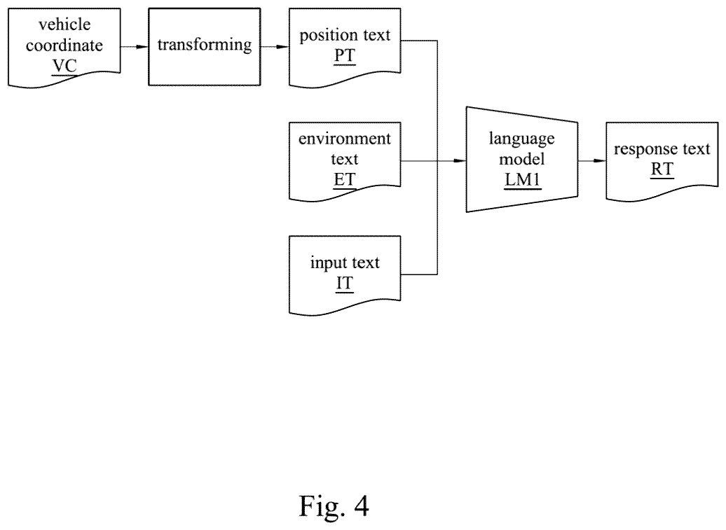

About the details of the language model LM1, please refer to FIG. 4, which is a flow diagram illustrating generating a response text RT by using a language model according to some embodiments of the present disclosure. In some embodiments, the language model LM1 is a large language model being trained for providing instructions.

In some embodiments, the vehicle-mounted apparatus 1 further takes the real-time location coordinate of the vehicle as a parameter and inputs the parameter into the language model LM1 for generating the response text RT. Since the language model LM1 has the characteristics of interpreting text, the processor 12 first transforms a vehicle coordinate VC (e.g., GPS coordinate) into a text indicating the location of the vehicle (e.g., address, road name), and then the processor 12 inputs the text into the language model LM1 as a parameter.

Specifically, in response to receiving the vehicle coordinate VC, the processor 12 transforms the vehicle coordinate VC into a position text PT; and the processor 12 inputs the position text PT and the environment text ET into the language model LM1 to generate the response text RT.

As shown in FIG. 4, in some embodiments, when the vehicle-mounted apparatus 1 receives the input data from the user (e.g., receiving via the aforementioned input interface), the vehicle-mounted apparatus 1 also inputs the input data in literal form (i.e., the input text IT) into the language model LM1 to generate the corresponding response text RT.

Specifically, in response to receiving the input text IT, the language model LM1 generates the response text RT based on the input text IT, wherein the response text RT responds to the input text IT.

For example, when the user asks a question such as “how can I get to my destination faster?”, the vehicle-mounted apparatus 1 inputs the user input in literal form into the language model LM1, and the language model LM1 is able to interpret the text and respond the question from the user. For example, the language model LM1 generates “Keep to speed up! Leave a good amount of space between your vehicle and the blue car on your right!” as the response.

As to the response text RT generated by the vehicle-mounted apparatus 1, the response text RT may be adjusted according to needs. Not only responding to the question from the user, the vehicle-mounted apparatus 1 may also proactively provide a driving suggestion based on the surrounding environment of the vehicle, or proactively starts a conversation.

In some embodiments, the language model LM1 provides a driving suggestion based on based on the surrounding environment of the vehicle. Specifically, the language model LM1 generates a driving suggestion for operating the vehicle based on the environment text ET; and the language model LM1 takes the driving suggestion as the first response text RT.

For example, when there is an obstacle approaching, the response text RT generated by the language model LM1 comprises an instruction to notice the user to slow down or dodge.

In some embodiments, the language model LM1 is able to take the initiative to talk to the user in order to help the user focus. Specifically, the language model LM1 generates an interactive data corresponding to the vehicle based on the environment text ET; and the language model LM1 take the interactive data as the first response text RT.

Furthermore, in some embodiments, when the vehicle-mounted apparatus 1 receives a response corresponding to the interactive data from the user (e.g., receiving via the aforementioned input interface), the language model LM1 then generates a response text RT corresponding to the response to continue the conversation.

Specifically, after generating the interactive data, in response to receiving the input text IT, the language model LM1 generates a response text RT based on the input text IT and the interactive data, wherein the response text RT responds to the input text IT.

For example, the language model LM1 starts a conversation by interesting question such as “Do you know what is the slowest car in the world?”. By this, the vehicle-mounted apparatus 1 simulates a scenario of chatting with the user (e.g., the driver) and helps reduce fatigue.

Furthermore, if the user replies “Tell me that what's the slowest car in the world?”, the language model LM1 then refers to both the question previously raised by itself (i.e., the response text RT previously generated) and the response of the user (i.e., the input text IT currently received) and generates response such as “Yeah, it's the blue car on your right! You should speed up!”.

In summary, the vehicle-mounted apparatus 1 provided by the present disclosure not only provide driving suggestions based on the surrounding environment of the vehicle, but also proactively starts a conversation for interaction. The conversation content incorporates the current driving scenario in order to help reduce fatigue of the driver and focus the driver's attention, thereby increase the vehicle safety while driving.

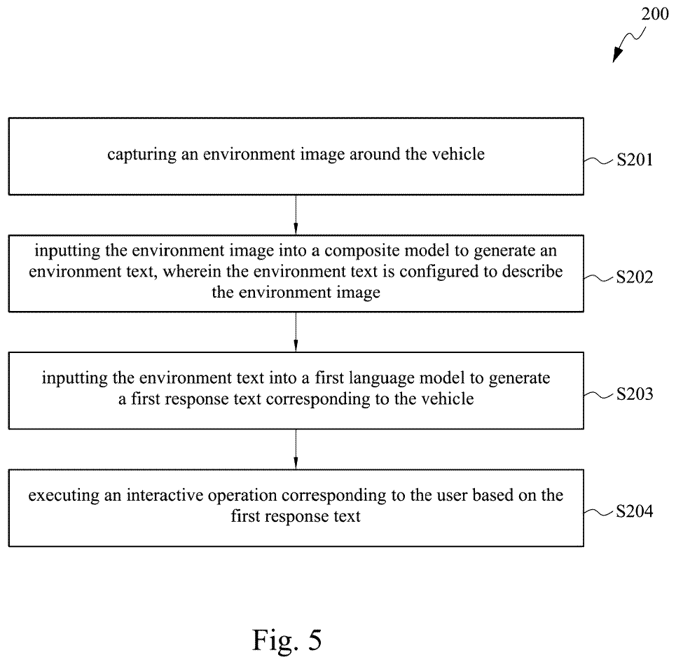

Please refer to FIG. 5, which is a flow diagram illustrating a vehicle-mounted apparatus control method 200 according to a second embodiment of the present disclosure. The vehicle-mounted apparatus control method 200 comprises steps S201-S204. The vehicle-mounted apparatus control method 200 is configured to provide content for interacting with the user based on the surrounding environment of the vehicle. The vehicle-mounted apparatus control method 200 can be executed by a vehicle-mounted apparatus (e.g., the vehicle-mounted apparatus 1 in the first embodiment), wherein the vehicle-mounted apparatus is installed on a vehicle a user ridden in.

First, in the step S201, the vehicle-mounted apparatus captures an environment image around the vehicle.

Next, in the step S202, the vehicle-mounted apparatus inputs the environment image into a composite model to generate an environment text, wherein the environment text is configured to describe the environment image.

Next, in the step S203, the vehicle-mounted apparatus inputs the environment text into a first language model to generate a first response text corresponding to the vehicle.

Finally, in the step S204, the vehicle-mounted apparatus executes an interactive operation corresponding to the user based on the first response text.

In some embodiments, the composite model is configured to input the environment image into an image encoder to generate a plurality of image features; input the image features and a query into a transformer model to generate a plurality of extracted features corresponding to a feature vector, wherein the query comprises the feature vector; and input the extracted features into a second language model to generate the environment text.

In some embodiments, the composite model is further configured to in response to receiving a real-time coordinate corresponding to the vehicle capturing the environment image, input the real-time coordinate, the image features, and the query into the transformer model to generate the extracted features.

In some embodiments, the composite model is further configured to in response to receiving the input data, generate the query based on the input data and the feature vector; and input the image features and the query into the transformer model to generate the extracted features.

In some embodiments, the second language model is a decoder corresponding to the image encoder and the transformer model.

In some embodiments, the vehicle-mounted apparatus control method 200 further comprises transforming a real-time coordinate corresponding to the vehicle capturing the environment image into a location text; and inputting the location text and the environment text into the first language model to generate the first response text.

In some embodiments, the first language model is further configured to in response to receiving the input text, generate the first response text based on the input text, wherein the first response text responds to the input text.

In some embodiments, the first language model is further configured to generate a driving suggestion for operating the vehicle based on the environment text; and take the driving suggestion as the first response text.

In some embodiments, the first language model is further configured to generate an interactive data corresponding to the vehicle based on the environment text; and take the interactive data as the first response text.

In some embodiments, the first language model is further configured to after generating the interactive data, in response to receiving the input text, generate a second response text based on the input text and the interactive data, wherein the second response text responds to the input text.

In summary, the vehicle-mounted apparatus control method 200 provided by the present disclosure not only provide driving suggestions based on the surrounding environment of the vehicle, but also proactively starts a conversation for interaction. The conversation content incorporates the current driving scenario in order to help reduce fatigue of the driver and focus the driver's attention, thereby increase the vehicle safety while driving.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A vehicle-mounted apparatus, installed on a vehicle a user ridden in, comprising:
a camera, configured to capture an environment image around the vehicle;
an output interface; and
a processor, communicatively connected to the camera and the output interface relatively, and configured to execute the following operations:
inputting the environment image into a composite model to generate an environment text, wherein the environment text is configured to describe the environment image;
inputting the environment text into a first language model to generate a first response text corresponding to the vehicle; and
generating a control signal corresponding to the first response text to control the output interface to execute an interactive operation corresponding to the user.

2. The vehicle-mounted apparatus of claim 1, wherein the composite model is configured to:
input the environment image into an image encoder to generate a plurality of image features;
input the image features and a query into a transformer model to generate a plurality of extracted features corresponding to a feature vector, wherein the query comprises the feature vector; and
input the extracted features into a second language model to generate the environment text.

3. The vehicle-mounted apparatus of claim 2, wherein the composite model is further configured to:
in response to receiving a real-time coordinate corresponding to the vehicle capturing the environment image, input the real-time coordinate, the image features, and the query into the transformer model to generate the extracted features.

4. The vehicle-mounted apparatus of claim 2, further comprising:
an input interface, configured to generate an input data corresponding to the user;
wherein the composite model is further configured to:
in response to receiving the input data, generate the query based on the input data and the feature vector; and
input the image features and the query into the transformer model to generate the extracted features.

5. The vehicle-mounted apparatus of claim 2, wherein the second language model is a decoder corresponding to the image encoder and the transformer model.

6. The vehicle-mounted apparatus of claim 1, wherein the processor is further configured to execute the following operations:
transforming a real-time coordinate corresponding to the vehicle capturing the environment image into a location text; and
inputting the location text and the environment text into the first language model to generate the first response text.

7. The vehicle-mounted apparatus of claim 1, further comprising:
an input interface, configured to generate an input text corresponding to the user;
wherein the first language model is further configured to:
in response to receiving the input text, generate the first response text based on the input text, wherein the first response text responds to the input text.

8. The vehicle-mounted apparatus of claim 1, wherein the first language model is further configured to:
generate a driving suggestion for operating the vehicle based on the environment text; and
take the driving suggestion as the first response text.

9. The vehicle-mounted apparatus of claim 1, wherein the first language model is further configured to:
generate an interactive data corresponding to the vehicle based on the environment text; and
take the interactive data as the first response text.

10. The vehicle-mounted apparatus of claim 9, further comprising:
an input interface, configured to generate an input text corresponding to the user;
wherein the first language model is further configured to:
after generating the interactive data, in response to receiving the input text, generate a second response text based on the input text and the interactive data, wherein the second response text responds to the input text.

11. A control method, being adapted for use in a vehicle-mounted apparatus, wherein the vehicle-mounted apparatus is installed on a vehicle a user ridden in, and the control method comprises the following steps:
capturing an environment image around the vehicle;
inputting the environment image into a composite model to generate an environment text, wherein the environment text is configured to describe the environment image;
inputting the environment text into a first language model to generate a first response text corresponding to the vehicle; and
executing an interactive operation corresponding to the user based on the first response text.

12. The control method of claim 11, wherein the composite model is configured to:
input the environment image into an image encoder to generate a plurality of image features;
input the image features and a query into a transformer model to generate a plurality of extracted features corresponding to a feature vector, wherein the query comprises the feature vector; and
input the extracted features into a second language model to generate the environment text.

13. The control method of claim 12, wherein the composite model is further configured to:
in response to receiving a real-time coordinate corresponding to the vehicle capturing the environment image, input the real-time coordinate, the image features, and the query into the transformer model to generate the extracted features.

14. The control method of claim 12, wherein the composite model is further configured to:
in response to receiving an input data corresponding to the user, generate the query based on the input data and the feature vector; and
input the image features and the query into the transformer model to generate the extracted features.

15. The control method of claim 12, wherein the second language model is a decoder corresponding to the image encoder and the transformer model.

16. The control method of claim 11, further comprising:
transforming a real-time coordinate corresponding to the vehicle capturing the environment image into a location text; and
inputting the location text and the environment text into the first language model to generate the first response text.

17. The control method of claim 11, wherein the first language model is further configured to:
in response to receiving an input text corresponding to the user, generate the first response text based on the input text, wherein the first response text responds to the input text.

18. The control method of claim 11, wherein the first language model is further configured to:
generate a driving suggestion for operating the vehicle based on the environment text; and
take the driving suggestion as the first response text.

19. The control method of claim 11, wherein the first language model is further configured to:
generate an interactive data corresponding to the vehicle based on the environment text; and
take the interactive data as the first response text.

20. The control method of claim 19, wherein the first language model is further configured to:
after generating the interactive data, in response to receiving an input text corresponding to the user, generate a second response text based on the input text and the interactive data, wherein the second response text responds to the input text.
